(19) United States
(12) Patent Application Publication
(10) Pub. No.: US 2026/0148617 A1
(43) Pub. Date: May 28, 2026

(54) System of Gameplay Comprised of Poker Hand Building Methods

(71) Applicant: Andrew Thomas Wood, Fort Recovery, OH (US)

(72) Inventor: Andrew Thomas Wood, Fort Recovery, OH (US)

(73) Assignee: Poker Peril LLC, Fort Recovery, OH (US)

(21) Appl. No.: 18/963,454

(22) Filed: Nov. 27, 2024

(51) Int. Cl. G07F 17/32

(52) U.S. Cl. CPC G07F 17/3293; G07F 17/3276

(57) ABSTRACT

The present invention is a new poker variation. There has not been an exciting and fun poker game brought forth for many years. This game is extremely easy to understand, yet has unbelievable strategy and depth. It is not a gambling poker game and can be played with 2, 3, and 4 players. It can be played using physical game apparatuses or with support from computer software, online servers, smart phone applications, gaming machines, and other screen display devices.

### FIELD

The present invention relates to card games, board games, and strategy games. The invention is a system of gameplay wherein playing cards are placed into respective spaces within designated sections to build common poker hands. The invention can be used with support from physical apparatuses such as printed table apparatuses. The invention can also be used with support from electronic platforms such as computers, mobile devices, gaming devices, casino devices, or any device able to incorporate the gameplay system into its processing system and or screen display.

### BACKGROUND

Card games have existed for centuries. Many card games are played throughout the world today. Poker is a card game genre which includes many variations. A majority of poker variations make use of the well-known 5-card poker hand. Common 5-card poker hands are a pair, two pair, three-of-a-kind, straight, flush, full house, four-of-a-kind, straight flush, and royal flush. These 5-card poker hands are used in popular poker variations such as Texas Hold'em, Stud, and 5-Card Draw. The present invention makes use of these common poker hands. The invention incorporates wild cards, which allows for an additional and highest-ranking poker hand of 5-of-a-kind. Jokers and wild cards are commonly understood by poker players. Wild cards are used primarily in a recreational setting due to their complexity, however one can notice the “Deuces Wild” variation of video poker gaming machines in most casinos. The present invention also makes use of a 2-card poker hand. This 2-card poker hand has a value ranking similar to commonly ranked 5-card poker hands, wherein a pair of Aces is the highest value, and cards of a similar suit are more valuable than non-suited.

### DESCRIPTION OF PRIOR ART

“Head-to-Head Poker” is a card/board game wherein two players try to make the best 5-card poker hands stemming from shared or communal cards. There are 3, 4, or 5 communal cards set out at the beginning of each round between both players on a game board. The style in which a round is played depends on a dice roll. Players either: draw 1 card and play that card; draw 2 cards, play one and give the other to the opponent; draw 3 cards, play one and refresh with 1 more; draw 4 cards, play all 4 and refresh with 4 more; reveal 5 cards face up, taking turns playing these cards then refreshing another 5 cards face up, or any of the previous styles combined with a “crazy” version where players can play on the opponent's side of the game board. This game also includes a betting/wagering mechanic wherein poker chips can be collected by betting out the opponent rather than having a winning poker hand. Betting is a common mechanic used in many poker variations.

Pai Gow Poker is a commonly played poker game that involves organizing a dealt sum of 7 cards into individual poker hands. Players organize and submit a 2- card poker hand in front of a 5-card poker hand simultaneously. All cards are submitted face or value side down. The 2-card poker hand must be lesser in value than the 5-card poker hand. A dealer follows the same action. Players compete against the dealer. A player must have higher valued poker hands than the dealer in both submitted poker hands to win fully. Pai Gow is commonly played in casinos.

Chinese Poker is a commonly played poker game that involves organizing a dealt sum of 13 cards into individual poker hands. Players organize and submit a 3-card hand, followed by a 5-card hand, followed by another 5-card hand. All cards are submitted simultaneously face or value side down. Poker hands must be of lesser value than those behind them, similar to Pai Gow. Players compete against each other and reveal all cards to score accordingly.

The main problems with Head-to-Head Poker are the use of shared communal cards, the use of a die to determine one of six play styles, a wagering mechanic, using only a portion of a standard playing card deck, limiting gameplay to three rounds, neglect of a 2-card hand, neglect of a discard space, neglect of using wild cards, neglect of face down cards, and use of a simple tie-breaking mechanic. The present invention does not include said communal cards, does not use any of the said six styles of gameplay, has no wagering mechanic, makes use of an entire deck of cards with even distribution, has a scoring limit rather than a round limit, incorporates the use of 2-card poker hands, incorporates the use of a discard section, incorporates the use of wild cards, incorporates face down cards, uses a unique tie-breaking mechanic, and allows for enhancements.

The main problem with Pai Gow and Chinese Poker is their simplistic mechanic of receiving all cards at once and submitting all poker hands at once. Another problem is the restrictive rule of the 2-card hand valuing higher than the 5-card hands. The present invention uses the mechanic of drawing 1 card per players'turn, playing one card per players'turn, and slowly building poker hands. The 2-card poker hand of the present invention does not have any value restrictions in relation to the 5-card poker hands.

### SUMMARY

The present system is comprised of three methods. In the first method, two players build five 5-card poker hands, as well as a 2-card poker hand. This method of the system is referred to as the “Two-Player” method.

In the second method, three players build three 5-card poker hands as well a 2-card poker hand, and make use of a discard. This method of the system is referred to as the “Three-Player” method.

In the third method, four players build two 5-card poker hands as well as a 2-card poker hand, and make use of a discard. This method of the system is referred to as the “Four-Player” method.

All three methods share similar mechanics of players being dealt five cards to begin, drawing one card per turn from the remaining deck, and playing one card per turn into designated sections and spaces until the deck is exhausted. All three methods make use of the entirety of a standard deck of playing cards with no cards being left over or any player receiving more than another.

All methods share a unique tie-breaking mechanic wherein multiple players reaching a winning score simultaneously continue gameplay until the tie is broken by a single highest score, allowing players with trailing scores to be potential victors.

The system can incorporate enhancement cards. Enhancement cards increase or decrease the likelihood for players to build certain poker hands, increase or decrease available information to players, as well as increase or decrease an award for winning poker hands. For instance, one enhancement allows a player to use a “2” as a wild card, allowing for an increase of potential poker hands. Another enhancement allows a player to play a card face down when it would normally be played face up, decreasing the amount of available information to other players. Another enhancement allows a player to receive two scoring units per winning poker hand rather than the unenhanced one scoring unit.

### BRIEF DESCRIPTION OF THE DRAWINGS

FIGS. 1-4 relate to the aforementioned “Two-Player” method. FIGS. 5-8 relate to the aforementioned “Three-Player” method. FIGS. 9-11 relate to the aforementioned “Four-Player” method. FIG. 12 relates to the aforementioned “enhancements”. While it is understood to use graphical images only when necessary: describing the present invention without, may have proved difficult, as it relies heavily on the use of graphical playing cards. Respectfully, the drawings are portrayed to support ease of explanation and understanding.

### DETAILED DESCRIPTION

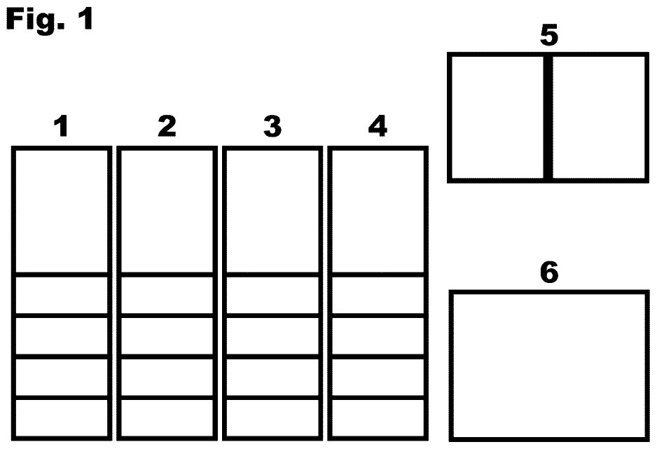

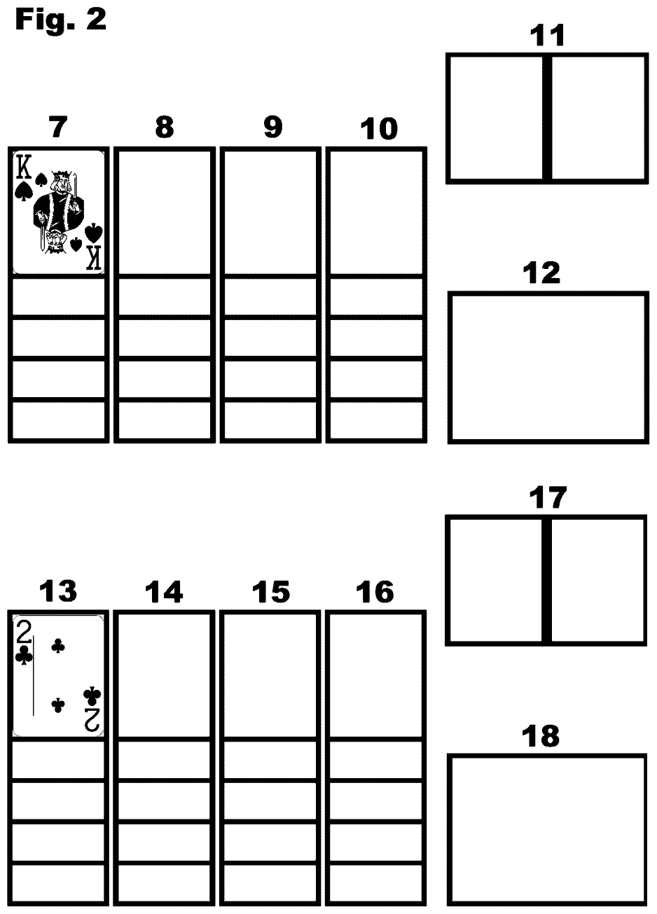

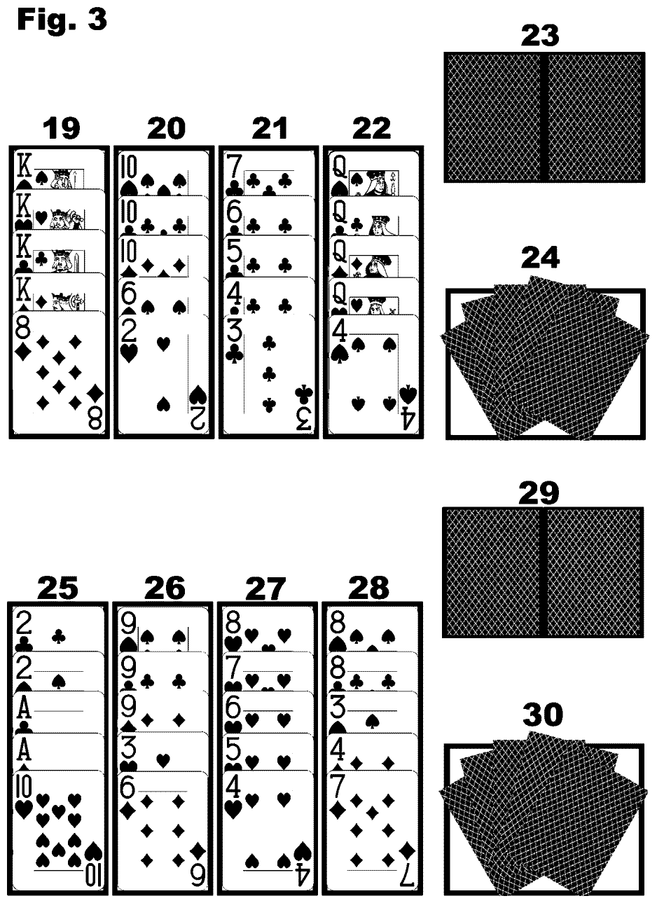

FIG. 1 shows an organization for use of the “Two-Player” method. Shown are designated sections with respective spaces for building poker hands. 1, 2, 3, and 4 allow 5-card poker hands to be built, one card face or value side up per user's turn. 5 shows a designated section with respective spaces for building a 2-card poker hand, one card face or value side down per user's turn. 6 shows a designated section with respective space for a fifth 5-card poker hand, played face or value side down after all other spaces are filled.

FIG. 2 shows a possible start of the use of the “Two-Player” method. One user has ownership of sections 7-12 and another user has ownership of sections 13-18. 7 and 13 show a single playing card played into a respective space for the initial building of a 5-card poker hand for each user.

FIG. 3 shows a possible outcome upon near completion of the use of the “Two-Player” method. 19, 20, 21, and 22 show fully built 5-card poker hands for one user. 25, 26, 27, and 28 show fully built 5-card poker hands for another user. 23 and 29 show the aforementioned 2-card poker hand for each user. 24 and 30 show the aforementioned fifth 5-card poker hand for each user.

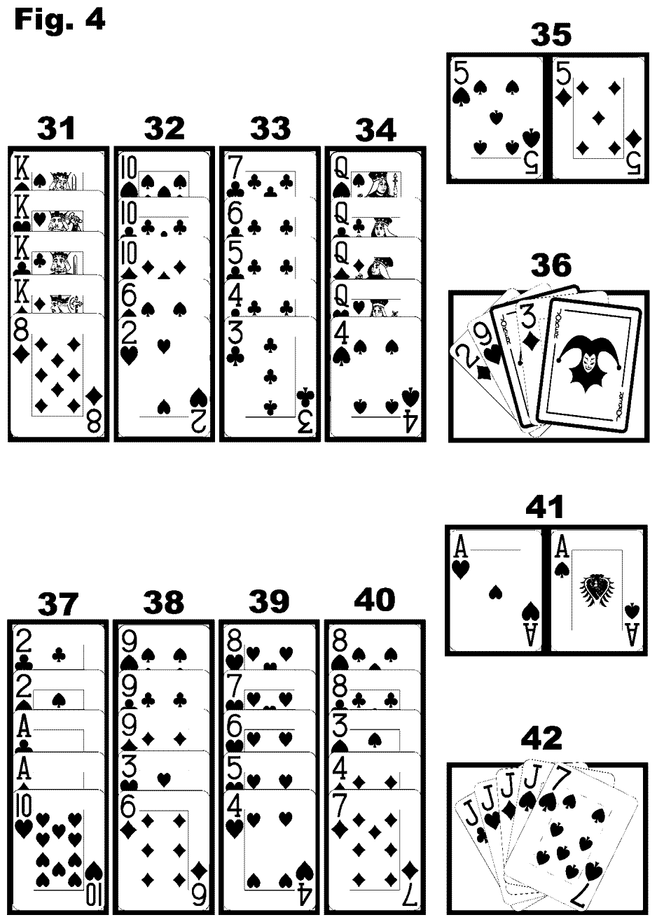

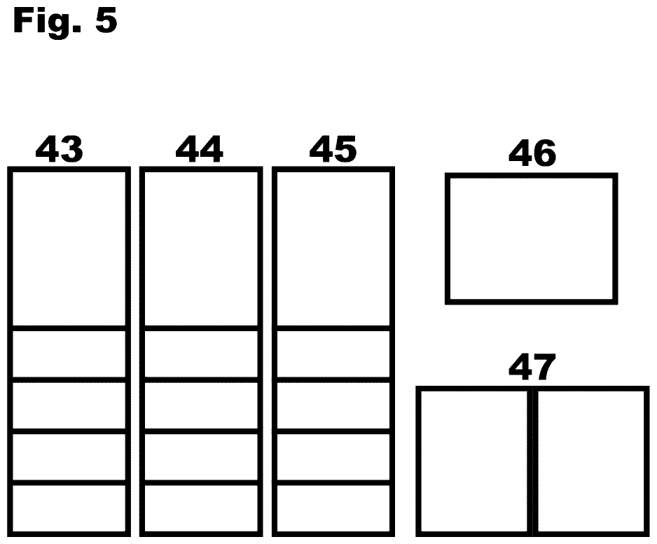

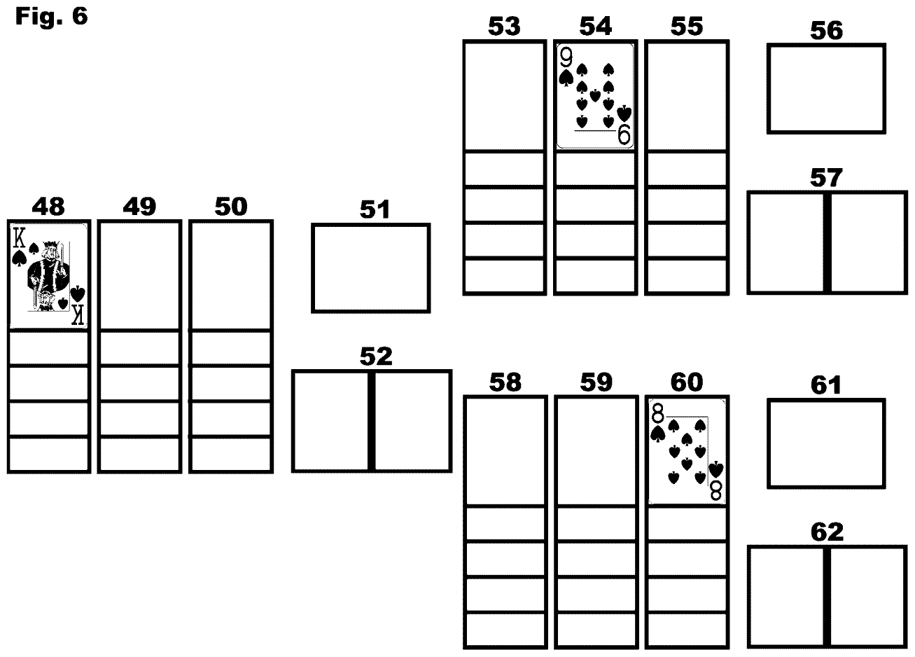

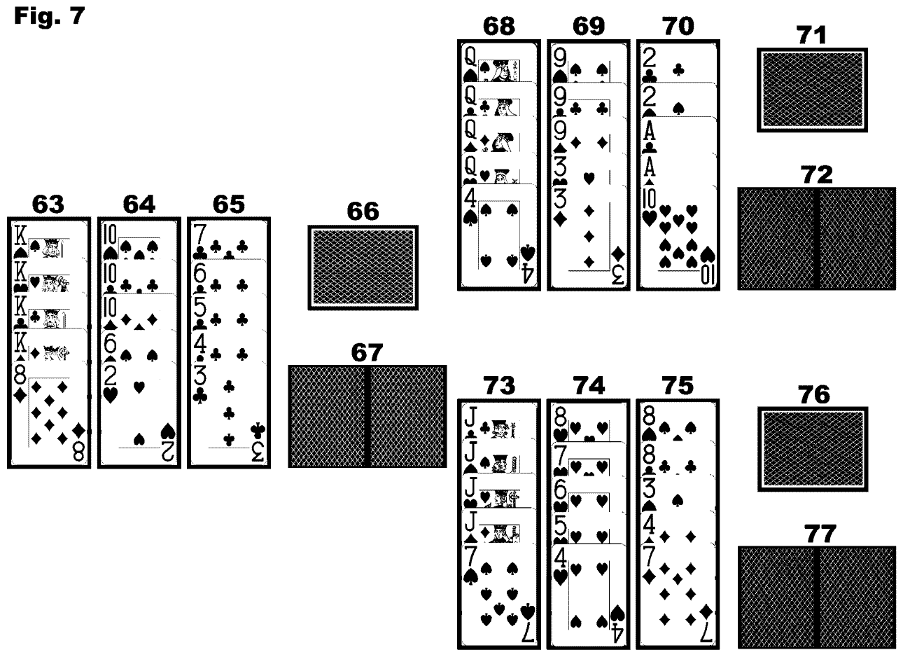

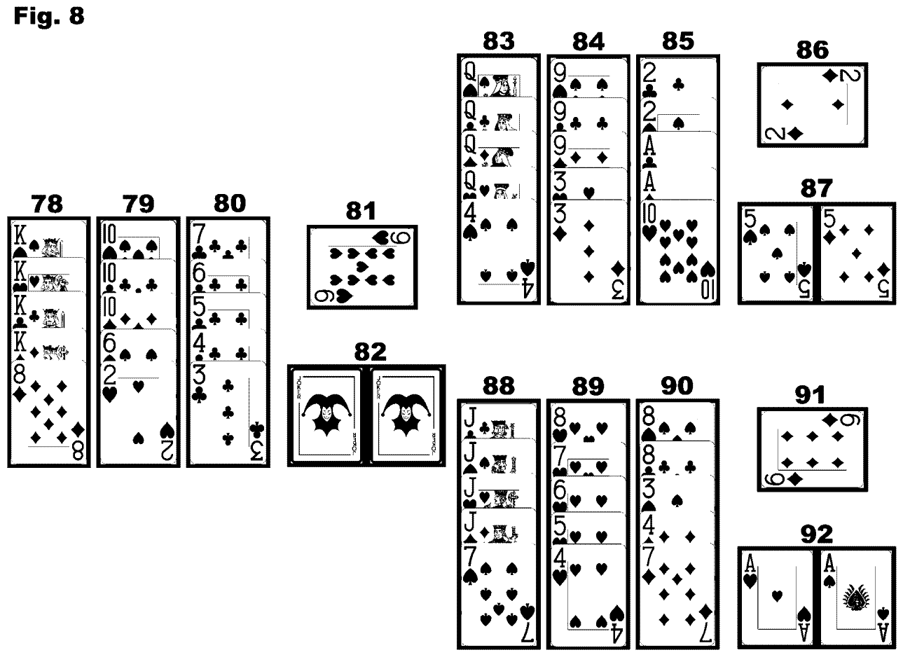

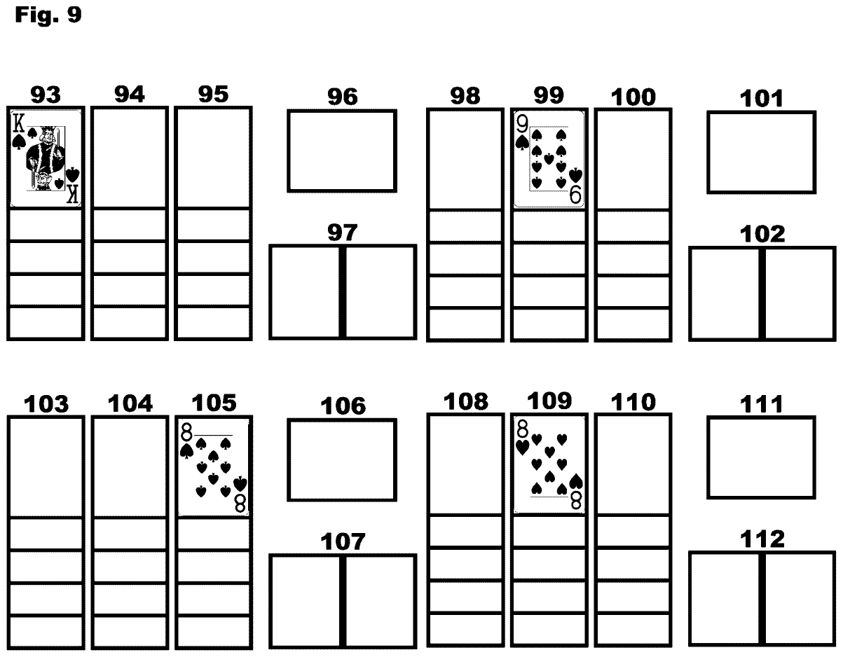

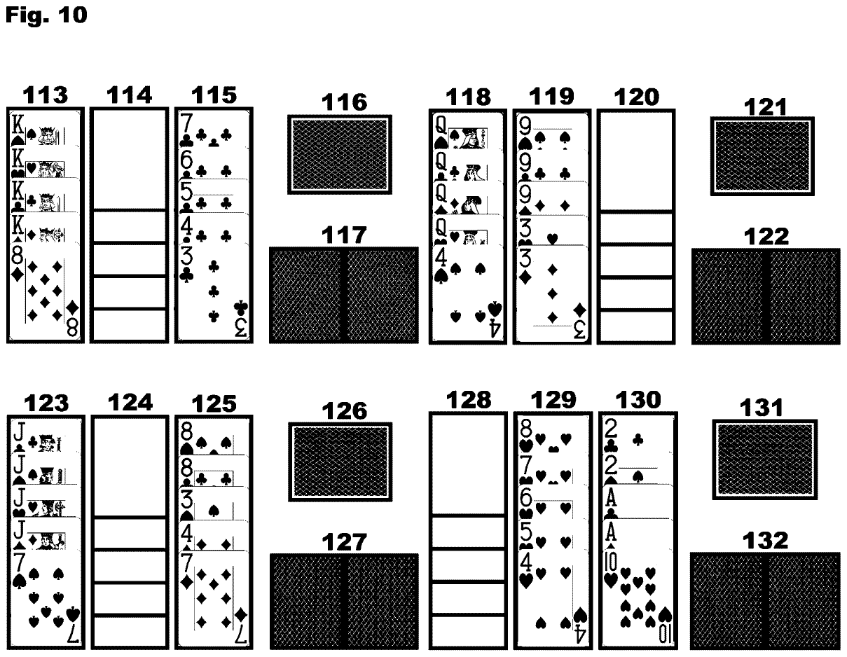

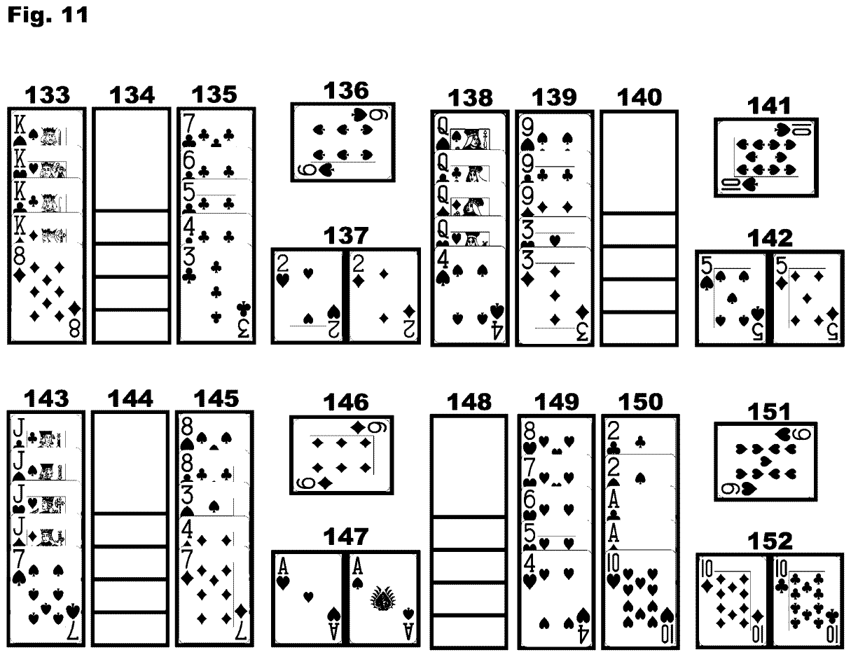

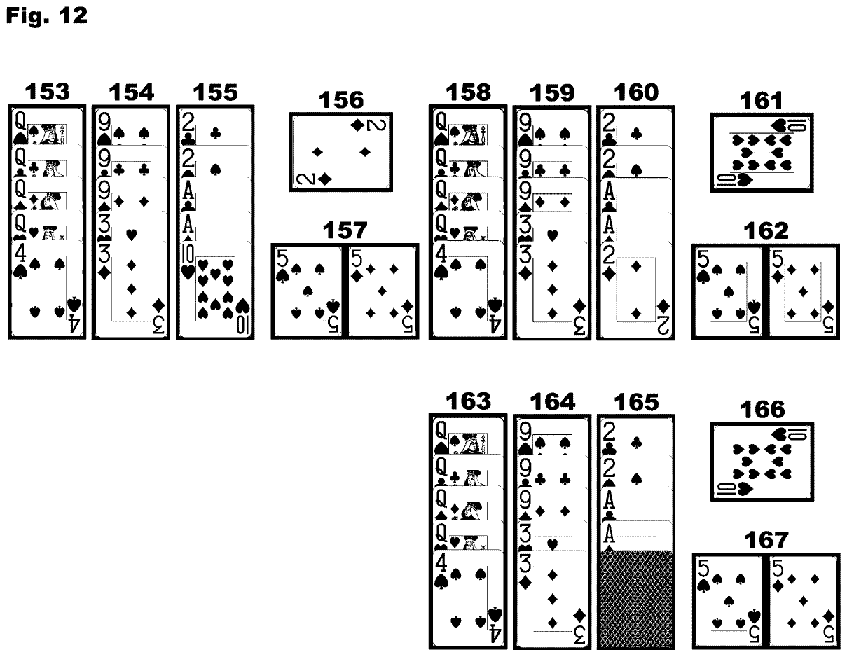

FIG. 4 shows a possible outcome upon completion of the use of the “Two-Player” method. All playing cards are turned face or value side up to be scored. All methods use the mechanic of scoring competing 5-card poker hands as well as scoring competing 2- card poker hands. 31 competes against 37. 32 competes against 38. 33 competes against 39, and 34 against 40. A user with ownership of poker hands in 31, 32, and 34 would receive three scoring units: one for building a winning poker hand in 31 (defeating an opponent's two pair shown in 37); another for a winning poker hand in 32 (defeating an opponent's inferior three of a kind shown in 38); and a final scoring unit for a winning hand in 34 (defeating an opponent's one pair shown in 40). A user with ownership of poker hand 39 receives one scoring unit for building a winning poker hand (defeating an opponent's inferior straight flush shown in 33).

A user with ownership of 41 receives one scoring unit for building a winning 2-card poker hand (defeating an opponent's inferior pair shown in competing section 35), as well as one scoring unit for a winning fifth 5-card poker hand in 42 (defeating an opponent's potential three of a kind shown in competing hand 36).

FIG. 5 shows an organization for the use of the previously mentioned “Three-Player” method. Shown are designated sections and respective spaces for building poker hands as well as a section for a playing card to be discarded. 43, 44, and 45 allow three 5-card poker hands to be built. 46 shows a designated section with respective space for the discarding of a playing card, not to be directly valued with any built poker hands. 47 shows a designated section with respective spaces for building a 2-card poker hand.

FIG. 6 shows a possible start of the use of the “Three-Player” method. 48-52 represent one user's ownership of poker hand sections and a discard space. 53-57 represent a second user's ownership of poker hand sections and a discard space. 58-62 represent a third user's ownership of poker hand sections and a discard space. 48, 54, and 60 show single playing cards used for the initial building of 5-card poker hands.

FIG. 7 shows a possible outcome upon near completion of the use of the “Three-Player” method. 63, 64, and 65 show fully built 5-card poker hands for one user. 68, 69, and 70 show fully built 5-card poker hands for a second user. And 73, 74, and 75 show fully built 5-card poker hands for a third user. 66, 71, and 76 show a discarded card that is played face or value side down for each user. 67, 72, and 77 show 2-card poker hands, played face or value side down for each user.

FIG. 8 shows a possible outcome upon completion of the use of the “Three-Player” method. All playing cards are turned face or value side up to be scored. This method includes scoring for competing 5-card poker hands as well as scoring for competing 2-card poker hands. 78, 83, and 88 are in competition. 79, 84, and 89 are in competition. 80, 85, and 90 are in competition. And 82, 87, and 92 are in competition. A user with ownership of poker hands 78 and 80 receives two scoring units: one for building a winning poker hand in 78 (defeating both opponents'inferior four-of-a-kinds shown in 83 and 88); and another scoring unit for building a winning poker hand in 80 (defeating an opponent's two pair in 85 and an opponent's pair shown in 90). A user with ownership of poker hand 89 receives one scoring unit for building a winning poker hand (defeating an opponent's three of a kind in 79, and an opponent's full house in 84). A user with ownership of poker hand 82 receives one scoring unit for a winning 2-card poker hand (Jokers being wild, giving this user the highest valued 2-card poker hand of a pair of Aces). A player with ownership of poker hand 92 also receives one scoring unit for building a tying winning 2-card poker hand.

FIG. 9 shows a possible start of the use of the “Four-Player” method wherein four users use similar organization as in the “Three Player” method. However, each user in this method may choose only two of the possible three 5-card poker hand sections. For instance, a user with ownership of sections 93, 94, and 95 may only build poker hands in two of the three sections. The same applies for all other users. 93, 99, 105, and 109 show a single playing card used for the initial building of 5-card poker hand for each user.

FIG. 10 shows a possible outcome upon near completion of the use of the “Four-Player” method. 113, 115, 118, 119, 123, 125, 129, and 130 show fully built 5-card poker hands. 116, 121, 126, and 131 show a respective space for the discarding of a playing card, to be played face or value side down, not to be directly valued within any built poker hands. 117, 122, 127, and 132 show 2-card poker hands, played face or value side down.

FIG. 11 shows a possible outcome upon completion of the use of the “Four-Player” method. All playing cards are turned face or value side up to be scored. In this example, a user with poker hand 133 would receive one scoring unit for a winning 5-card poker hand competing against 138, 143, and 148. A user with poker hand 135 would receive one scoring unit for a winning poker hand competing against 140, 145, and 150. A user with poker hand 149 would receive one scoring unit for a winning poker hand competing against 134, 139, and 144. And a user with poker hand 147 would receive one scoring unit for a winning 2-card poker hand, competing against 137, 142, and 152.

FIG. 12 shows possible use of enhancements. 153-157 show unenhanced poker hands and a discard. 160 and 161 reflect the enhancement of 155 and 156 by swapping two played cards. 155 has upgraded from two pair to a full house in 160. 165 reflects an enhancement of 155 by playing a card face or value side down in order to conceal information. The user with ownership of poker hand 160 could use a wild 2s enhancement, upgrading the full house to five-of-a-kind. 158 and 160 may also be eligible for the enhancement of double scoring units awarded to winning four-of-a-kinds, and or winning five-of-a-kinds if paired with the wild 2s enhancement. Enhancements increase or decrease the likelihood to build certain poker hands, increase or decrease the value of poker hands, increase or decrease available information about poker hands, and or increase or decrease awards for winning poker hands.

1. The invention claimed is a system of methods including poker hand building and other mechanics comprising:
a two-player method wherein users utilize said designated sections and respective spaces to build five competing 5-card poker hands and competing 2-card poker hands;
a three-player method wherein users utilize said designated sections and respective spaces to build three competing 5-card poker hands, competing 2-card poker hands, and making use of a discard;
a four-player method wherein users utilize said designated sections and respective spaces to build two competing 5-card poker hands, competing 2-card poker hands, and making use of a discard.

2. The system as in claim 1, wherein said users receive an award or awards when their built poker hands have the highest value or highest tying values among all users'competing poker hands.

3. The system as in claim 1, comprising any enhancements to said poker hands which increase or decrease the likelihood to build certain poker hands, increase or decrease the value of poker hands, increase or decrease available information about poker hands, and or increase or decrease awards for winning poker hands.

4. The system as in claim 1, comprising any organization of said sections and spaces with use of, but not limited to, physical apparatuses, electronically displayed screen, computing software, online networks, and or internet-based servers.

5. The system as in claim 1, wherein said users are comprised of, but not limited, to human users, automated users, computer processors, and or any form of user able to utilize said system.

6. The system as in claim 1, comprising said poker hands to be formed with any type of playing card or objects, such as, but not limited to, cards with valued colors, cards with valued numerals, cards with valued graphics, and or cards with valued shapes.
